(19) United States
(12) Patent Application Publication
(10) Pub. No.: US 2012/0262282 A1
(43) Pub. Date: Oct. 18, 2012

(54) Hanging Fan Control Circuit for Controlling Clockwise/Counterclockwise Rotation Direction and Rotation Speed

(75) Inventor: Kuo Tsun Lin, Taichung City (TW)

(73) Assignee: Chao-Chin Yao, Taichung City (TW)

(21) Appl. No.: 13/084,794

(22) Filed: Apr. 12, 2011

(51) Int. Cl. G05B 11/01

(52) U.S. Cl. 340/12.32

(57) ABSTRACT

A hanging fan control circuit for controlling a clockwise/counterclockwise rotation and a rotation speed comprises a zero circuit including an integrating circuit for converting an external AC power at a different frequency into a DC power at a different voltage and transmitting a power signal to a central processing unit. The central processing unit distinguishes the DC power as a high potential and switches a power off switch to interrupt the power which is distinguished as a low potential. A speed adjusting instruction or a clockwise/counterclockwise rotation switching instruction can be determined according to a time interval of the change of the high potential or low potential, and different control signals will be transmitted to a triphase motor driving module according to different instructions for driving and rotating a brushless motor to achieve a correct operation of the hanging fan.

### BACKGROUND OF THE INVENTION

1. Field of the Invention

The present invention relates to a hanging fan control circuit for controlling a clockwise/counterclockwise rotation and a rotation speed of a hanging fan, in particular to a hanging fan control circuit applicable for inputting power of different frequencies.

2. Description of the Related Art

A conventional hanging fan control circuit for controlling a clockwise/counterclockwise rotation and a rotation speed adopts a power frequency detection circuit (as shown in FIG. 3) to convert a sine wave signal of an external AC power into a square wave signal, such that the power can be interrupted temporarily when a user pulls a hanging fan switch, and a central processing unit installed in the control circuit includes a control program for determining a time duration of the interrupt of the square wave signal in order to determine a speed adjusting instruction and a clockwise/counterclockwise rotation switching instruction for driving the hanging fan correctly.

However, different countries provide different AC powers at different frequencies, and the power frequency detection circuit installed in the control circuit can only distinguish a certain specific frequency, such that a misjudgment may be made by the control circuit for the AC power input with a different frequency to result in an abnormal operation of the hanging fan. If different control circuits are designed for the input of powers at different frequencies, the production cost will be very high, and the material and warehouse management will be a big issue.

Since the conventional hanging fan uses the time interval of the temporary interrupt of the power caused by pulling the hanging fan switch by the user as a basis for determining the speed adjustment or the clockwise/counterclockwise rotation switching, the power restoration requires converting the external AC power from the sine wave signal into the square wave signal again after the power interrupt takes place, and the program installed in the power frequency detection circuit will become complicated and will result in an issue of a slow processing.

### SUMMARY OF THE INVENTION

Therefore, it is a primary objective of the invention to provide a hanging fan control circuit for controlling the clockwise/counterclockwise rotation and the rotation speed, and the hanging fan control circuit is applicable for the input of power at different frequencies.

Another objective of the present invention is to provide a hanging fan control circuit for controlling a clockwise/counterclockwise rotation and a rotation speed, and the hanging fan control circuit is applicable for the input of power at different frequencies, so as to achieve the effects of simplifying the manufacturing process, lowering the production cost, and facilitating the production management.

A further objective of the present invention is to provide a hanging fan control circuit for controlling a clockwise/counterclockwise rotation and a rotation speed, and the hanging fan control circuit has a simplified control program to achieve a high-performance processing effect.

To achieve the foregoing objectives, the present invention provides a hanging fan control circuit for controlling a clockwise/counterclockwise rotation and a rotation speed, and the hanging fan control circuit comprises:

a power off switch, coupled to an external AC power, for switching the power off switch to temporarily interrupt an input of the external AC power;

a zero circuit, for receiving an input of the external AC power, and outputting a power signal, and the zero circuit having an integrating circuit for converting an AC power of a different frequency into a DC power of a different voltage;

a central processing unit, coupled to the zero circuit, and containing a control program installed therein for detecting an AC voltage converted by the zero circuit and distinguishing a high potential or a low potential, and the central processing unit determining whether an instruction is one for adjusting a speed or switching a clockwise/counterclockwise rotation based on the time interval of a change of the high potential or the low potential, and then outputting a different control signal according to the different instruction;

a triphase motor driving module, coupled to the central processing unit and a brushless motor of the hanging fan, for receiving the control signal transmitted from the central processing unit to drive and rotate the brushless motor;

a rectifier and filter circuit, for receiving an input of the external AC power input and coupling to the triphase motor driving module; and

a buck circuit, coupled to the zero circuit and the central processing unit, for supplying a system power to the hanging fan control circuit.

### BRIEF DESCRIPTION OF THE DRAWINGS

FIG. 1 is a schematic structural block diagram of the present invention;

FIG. 2 is a circuit diagram of a zero circuit of the present invention; and

FIG. 3 is circuit diagram of a power frequency detection circuit of a conventional hanging fan control circuit.

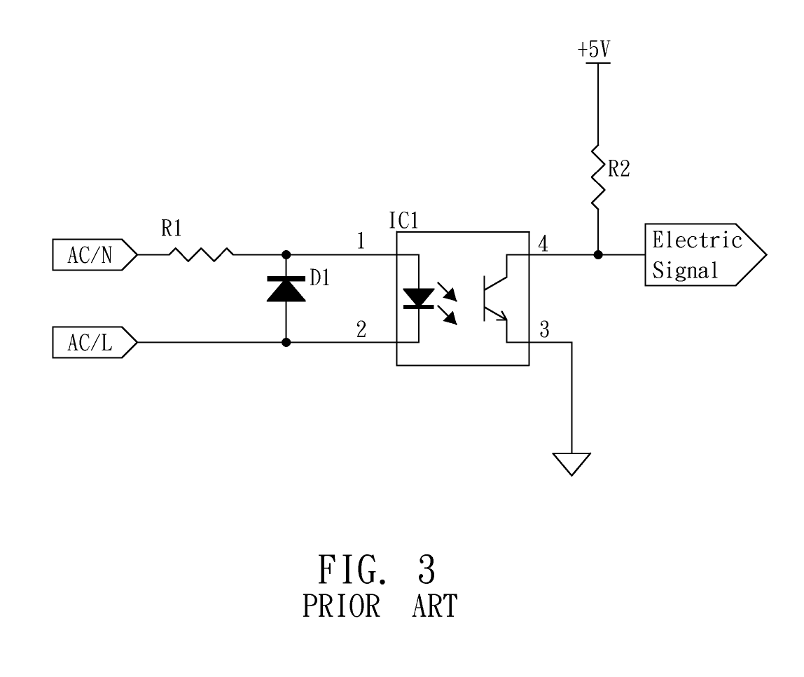

### DETAILED DESCRIPTION OF THE PREFERRED EMBODIMENTS

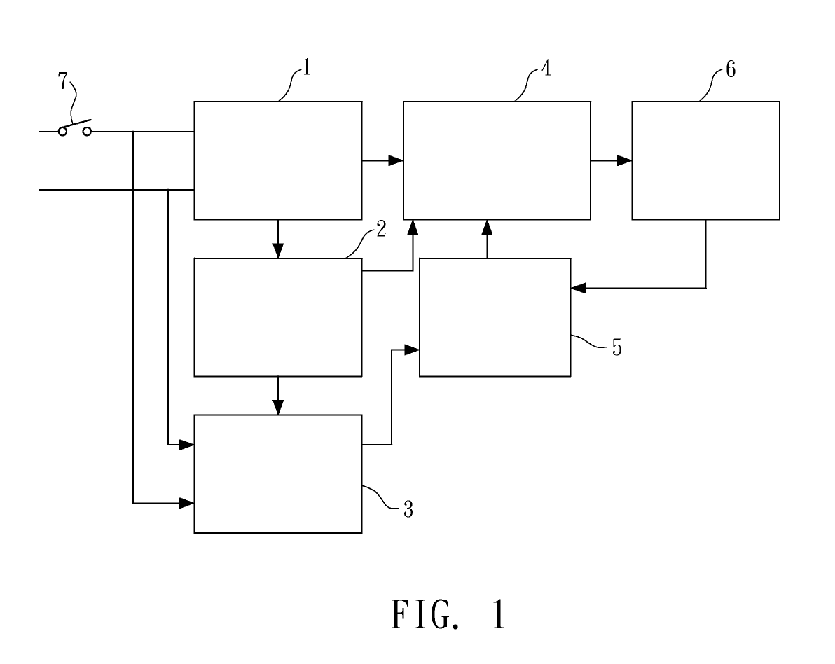

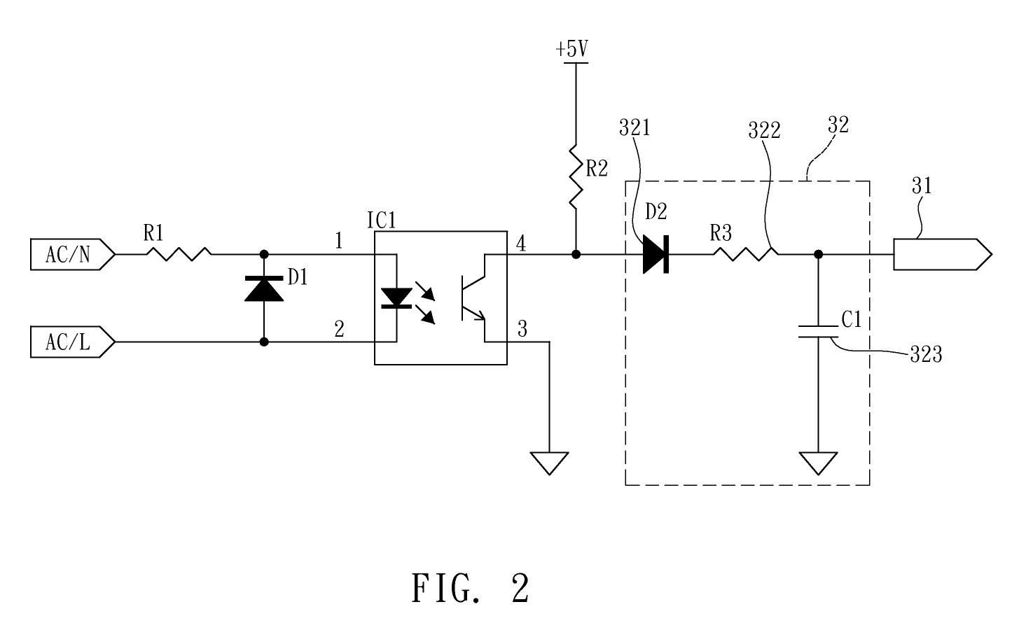

With reference to FIGS. 1 and 2 for a hanging fan control circuit for controlling a clockwise/counterclockwise rotation and a rotation speed in accordance with the present invention, the hanging fan control circuit comprises:

a power off switch 7, coupled to an external AC power, and switchable for temporarily interrupting an input of an external AC power;

a zero circuit 3, for receiving the input of the external AC power, and outputting a power signal 31, and the zero circuit 3 having an integrating circuit 32 installed therein for converting an AC power at a different frequency into a DC power at a different voltage, wherein in this preferred embodiment, the integrating circuit receives an AC power at a frequency of 60 Hz and converts the AC power into a DC power at a voltage of 5V; and the integrating circuit receives an AC power at a frequency of 50 Hz and converts the AC power into a DC power at a voltage of 4.5V, and the integrating circuit 32 is comprised of a diode 321, a resistor 322 and a capacitor 323 connected in series with one another, and another end of the capacitor 323 is grounded, and the integrating circuit 32 is connected in series with a front end of the zero circuit 3 for outputting a power signal;

a central processing unit 5, coupled to the zero circuit 3, and having a control program installed therein for detecting a DC voltage converted by the zero circuit 3 and distinguishing the detected voltage into a high potential or a low potential such as 2.5V (which is used as a standard, and any voltage higher than 2.5V is considered as a high potential and any voltage less than 2.5V is considered as a low potential), and the time interval for the interrupt of the DC voltage by pressing the power off switch 7 is determined as a speed adjusting instruction or a clockwise/counterclockwise rotation switching instruction, and then a different control signal is outputted according to a different instruction;

a triphase motor driving module 4, coupled to the central processing unit 5 and a brushless motor 6 of the hanging fan, for receiving the control signal transmitted from the central processing unit 5 to drive and rotate the brushless motor 6;

a rectifier and filter circuit 1, for receiving an input of an external AC power and coupling to the triphase motor driving module 4; and

a buck circuit 2, coupled to the zero circuit 3 and the central processing unit 5, for supplying a system power to the hanging fan control circuit.

In practical applications, the present invention not only limits an input of AC power at a certain specific frequency, but also adopts the integrating circuit 32 installed in the zero circuit 3 to convert the AC power at the frequency 60 Hz or 50 Hz into a DC power at the voltage of 5V or 4.5V, and the control program of the central processing unit 5 adopts 2.5V as the standard for distinguishing the high or low potential. Regardless of the input of the AC current at the frequency of 60 Hz or 50 Hz, the central processing unit 5 will consider the AC current as a high potential, so as to avoid any misjudgment made by the control program and caused by the input of AC current at a different frequency.

If a temporary interrupt of power occurs due to the switching of the power off switch 7, the voltage of the DC power converted by the integrating circuit 32 will drop to zero and output a power signal 31. Now, the central processing unit 5 determines that the power is of a low potential, and restores the power to the high potential after the power is resumed, wherein the central processing unit 5 uses the time interval of the change of high and low potentials (such as the time of maintaining the low potential less than one second is considered as a speed adjusting instruction) to drive the triphase motor driving module 4 to transmit a speed adjusting signal to drive and rotate the brushless motor 6, and the time of maintaining the low potential more than 3 seconds while switching the power off switch 7 is considered by the central processing unit as a clockwise/counterclockwise rotation switching instruction, and an end signal is issued to stop the inertia of the rotation of the motor, and then a reverse rotating control signal is issued to rotate the motor in a reverse direction.

When the power off switch 7 is switched to resume the power after the temporary interrupt takes place, the external AC power is converted into the DC power by the integrating circuit 32 in a physical way, after which a signal of a high or low potential results, and is transmitted to the central processing unit 5. Therefore, the present invention can simplify the program of the hanging fan control circuit and expedite the computation of the central processing unit 5.

What is claimed is:

1. A hanging fan control circuit for controlling a clockwise/counterclockwise rotation and a rotation speed, comprising:
a power off switch, coupled to an external AC power, and switchable for temporarily interrupting an input of the external AC power;
a zero circuit, for receiving the input of the external AC power, and outputting a power signal, and the zero circuit including an integrating circuit for converting an AC power of a different frequency into a DC power of a different voltage;
a central processing unit, coupled to the zero circuit, and including a control program installed therein for detecting a DC voltage converted by the zero circuit, and distinguishing the DC voltage as either a high potential or a low potential, and the central processing unit determining a speed adjusting instruction or a clockwise/counterclockwise rotation switching instruction according to the time interval of a change of high potential or low potential, and then outputting a different control signal for a different instruction;
a triphase motor driving module, coupled to the central processing unit and a brushless motor of the hanging fan, for receiving a control signal transmitted from the central processing unit to drive and rotate the brushless motor;
a rectifier and filter circuit, for receiving an input of the external AC power, and coupling to the triphase motor driving module;
a buck circuit, coupled to the zero circuit and the central processing unit, for supplying a system power to the hanging fan control circuit.

2. The hanging fan control circuit for controlling a clockwise/counterclockwise rotation and a rotation speed as recited in claim 1, wherein the integrating circuit of zero circuit is comprised of a diode, a resistor and a capacitor connected in series with one another, and another end of the capacitor is grounded, and the integrating circuit is connected in series with a front end of the zero circuit for outputting a power signal.
